(19) United States
(12) Patent Application Publication
(10) Pub. No.: US 2015/0362121 A1
(43) Pub. Date: Dec. 17, 2015

(54) SPANNER-CONTROLLED PANEL MEMBER COUPLING STRUCTURE

(71) Applicant: HANWIT PRECISION INDUSTRIES LTD., New Taipei City (TW)

(72) Inventor: Ying-Chih TSENG, New Taipei City (TW)

(21) Appl. No.: 14/306,894

(22) Filed: Jun. 17, 2014

(51) Int. Cl. F16M 13/02

(52) U.S. Cl. CPC F16M 13/02

(57) ABSTRACT

A spanner-controlled panel member coupling structure includes a base frame, a sliding panel accommodated in the base frame and movable between an extended position outside said base frame and a received position inside said base frame, a spanner pivotally coupled to the sliding panel and operable to move the sliding panel between the received position and the extended position, and a rotary actuator connected to the spanner for moving a spring-loaded axle member between a locking position to lock the sliding panel to the base frame and an unlocking position to unlock the sliding panel from the base frame when a user biases the spanner relative to the base frame to move the sliding panel between the received position and the extended position.

### BACKGROUND OF THE INVENTION

1. Field of the Invention

The present invention relates to a panel member coupling design for joining a sliding panel and a base frame and more particularly, to a spanner-controlled panel member coupling structure, which uses an actuator for locking the sliding panel to the base frame and a spanner for moving the actuator between a locking position and an unlocking position and the sliding panel between a received position inside the base frame and an extended position outside the base frame.

2. Description of the Related Art

With continuous innovation and progress of computer technology, the application of computers and many other electric and electronic products has been greatly enhanced and improved. A conventional desk computer has the disadvantages of large size and low mobility. It is not practical to carry a desk computer and the related peripheral apparatuses for application in different places. To eliminate these problems, notebook computer is created. However, a notebook computer still has a certain weight and can get hot easily. When using a notebook, the user must open the cover member that has a display screen mounted therein from the base member that has a keyboard embedded therein. In recent years, various tablet computers and smart phones are designed for ease of use and high performance mobility. However, the amount of applicable peripheral devices and memory capacity of a tablet computer or smart phone are limited due to size restriction. Further, a desk computer has better data storage capacity expandability than a tablet computer or smart phone, and allows connection of multiple peripheral devices such as keyboard, mouse, printer, mobile hard disk drive, mobile memory device, and etc. People would like to use a desk computer in the office or other fixed workplace rather than a tablet computer. A desk computer generally has an expansion slot for the mounting of a detachable hard disk drive, CD-ROM or multimedia player in a detachable manner. The use of a detachable hard disk drive, CD-ROM or multimedia player in a desk computer does not occupy any extra desk top surface. An expansion slot of a desk computer generally comprises a frame structure defining therein an accommodation chamber for receiving a detachable electronic device, and an electrical connector mounted in the frame structure for the connection of a mating electrical connector of the inserted detachable electronic device. However, when mounting a detachable electronic device in an expansion slot of a desk, the user must heavily push the detachable electronic device toward the inside of the desk computer after its insertion into the expansion slot to ensure positive connection between the mating electrical connector of the detachable electronic device and the electrical connector in the expansion slot. However, when pushing the detachable electronic device into the expansion slot heavily, the electrical connector in the expansion slot can be damaged accidentally. Further, a detachable electronic device generally has a fixed handle or swivel handle for gripping. When pulling the fixed handle or swivel handle to move the mobile electronic device out of the expansion slot, the mobile electronic device can be horizontally biased, causing impact against the frame of the expansion slot. An improvement in this regard is desired.

### SUMMARY OF THE INVENTION

The present invention has been accomplished under the circumstances in view. It is therefore the main object of the present invention to provide a spanner-controlled panel member coupling structure, which facilitates installation of a detachable electronic device in a panel member without causing damage.

To achieve this and other objects of the present invention, a spanner-controlled panel member coupling structure of the present invention comprises a base frame, a sliding panel accommodated in the base frame and movable between an extended position outside said base frame and a received position inside said base frame, a spanner pivotally coupled to a through hole and an arched sliding slot of the sliding panel and operable to move the sliding panel between the received position and the extended position, and a rotary actuator connected to the spanner for moving a spring-loaded axle member between a locking position to lock the sliding panel to the base frame and an unlocking position to unlock the sliding panel from the base frame when a user biases the spanner relative to the base frame to move the sliding panel between the received position and the extended position.

Further, the pusher of the spanner is U-shaped, comprising a locating portion and a pushing portion respectively located at two distal ends thereof; the base frame comprises a position-limit structure that comprises a retaining slot and a locating slot aligned in line for receiving the locating portion and pushing portion of the pusher of the spanner respectively; the sliding panel comprises a position-limit guide that comprises an elongated sliding guide slot located in one upright sidewall of the sliding panel corresponding to the aligned retaining slot and locating slot of the position-limit structure for receiving the locating portion and pushing portion of the pusher of the spanner.

Further, the spanner head of the spanner comprises at least one retaining hole disposed adjacent to the mating coupling hole; the base member of the rotary actuator comprises at least one retaining protrusion located at a bottom side thereof and respectively fastened to said at least one retaining hole of the spanner head of the spanner.

Further, the rotary actuator comprises a base member affixed to the spanner head of the spanner, a holder member mounted in the base member, an axle member mounted in the holder member axially movable between a locking position where the axle member is engaged into the through hole of the sliding panel and an axle hole of the base frame and an unlocking position where the axle member is disengaged from the through hole of the sliding panel and the axle hole of the base frame, a spring member mounted in the holder member and adapted to hold the axle member in the locking position, a cap member affixed to a top end of the axle member outside the holder member, a rotary socket affixed to the cap member, and two mating curved tracks respectively located at the base member and the rotary socket and mating each other for guiding rotation of the rotary socket relative to the base member to move the axle member between the locking position and the unlocking position when a user biases the spanner handle of the spanner in or out of the notch of the sliding panel and the notch of the base frame.

Further, the two curved tracks are respectively located at the bottom side of the rotary socket and the top side of the base member. Each curved track comprises two opposite lifting portions, two homing grooves equally spaced between the lifting portions at two opposite sides, two sloping guide surfaces respectively downwardly extended from respective one ends of the lifting portions to respective one ends of the homing grooves, and two upright stop edges respectively connected between respective opposite ends of the lifting portions and respective opposite ends of the sloping guide surfaces.

### BRIEF DESCRIPTION OF THE DRAWINGS

FIG. 1 is an oblique top elevational view of a spanner-controlled panel member coupling structure in accordance with a first embodiment of the present invention.

FIG. 2 is an exploded view of the spanner-controlled panel member coupling structure in accordance with the first embodiment of the present invention.

FIG. 3 corresponds to FIG. 2 when viewed from another angle.

FIG. 4 is a schematic sectional side view of the spanner-controlled panel member coupling structure in accordance with the first embodiment of the present invention.

FIG. 5 is a schematic top view of the first embodiment of the present invention, illustrating a status of the spanner-controlled panel member coupling structure before operation of the spanner.

FIG. 6 corresponds to FIG. 5, illustrating the spanner operated.

FIG. 7 is another schematic sectional side view of the spanner-controlled panel member coupling structure in accordance with the first embodiment of the present invention.

FIG. 8 is a top view of the first embodiment of the present invention, illustrating the spanner operated and the sliding panel moved out of the base frame.

FIG. 9 is an oblique elevational view of the first embodiment of the present invention, illustrating the spanner operated and the sliding panel moved out of the base frame.

FIG. 10 is a schematic top view of a spanner-controlled panel member coupling structure in accordance with a second embodiment of the present invention.

FIG. 11 is a sectional side view of the spanner-controlled panel member coupling structure in accordance with the second embodiment of the present invention.

FIG. 12 corresponds to FIG. 10, illustrating the spanner turned out of the notch of the sliding panel and the notch of the base frame.

FIG. 13 corresponds to FIG. 12, illustrating the sliding panel extended out of the base frame.

FIG. 14 is a schematic top view of a spanner-controlled panel member coupling structure in accordance with a third embodiment of the present invention.

FIG. 15 is a sectional side view of the spanner-controlled panel member coupling structure in accordance with the third embodiment of the present invention.

FIG. 16 corresponds to FIG. 14, illustrating the spanner turned out of the notch of the sliding panel and the notch of the base frame.

FIG. 17 corresponds to FIG. 16, illustrating the sliding panel extended out of the base frame.

### DETAILED DESCRIPTION OF THE PREFERRED EMBODIMENT

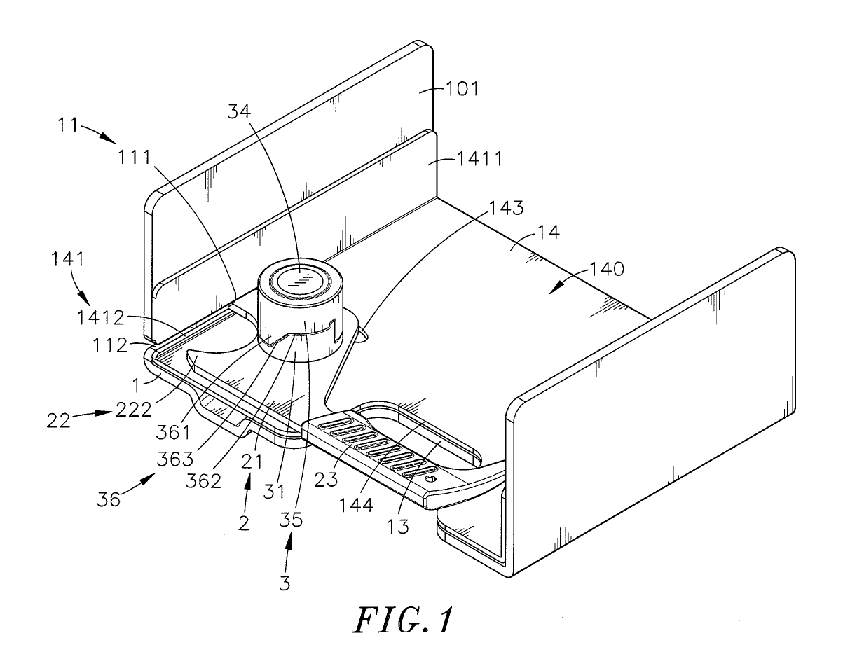

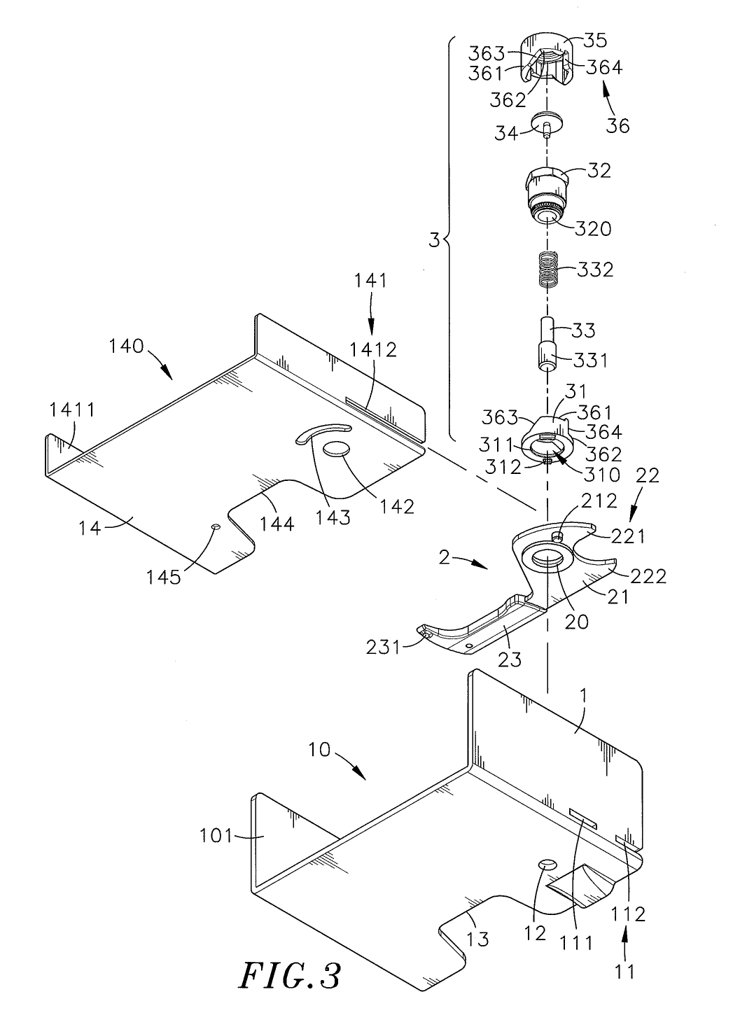

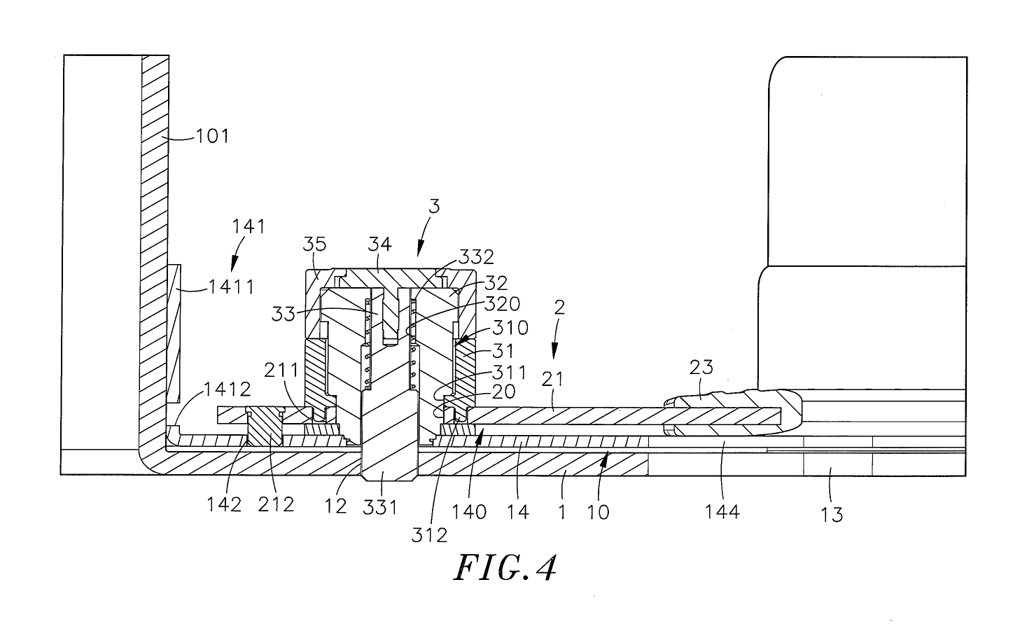

Referring to FIGS. 1-4, a spanner-controlled panel member coupling structure in accordance with a first embodiment of the present invention is shown. The spanner-controlled panel member coupling structure comprises a base frame 1, a sliding panel 14, a spanner 2, and a rotary actuator 3.

The base frame 1 is a substantially U-shaped frame member, comprising an accommodation chamber 10, a position-limit structure 11 located in one upright sidewall 101 of the accommodation chamber 10, and an axle hole 12 and a notch 13 located in a bottom side of the accommodation chamber 10. The position-limit structure 11 comprises a retaining slot 111 and a locating slot 112 aligned in line. The sliding panel 14 is a substantially U-shaped panel movable in and out of the accommodation chamber 10 between an extended position and a received position, comprising a receiving space 140, a position-limit guide 141 disposed at one lateral side of the receiving space 140, a through hole 142 vertically cut through opposing top and bottom surfaces thereof in communication with the receiving space 140, an arched sliding slot 143 vertically cut through the opposing top and bottom surfaces and extending around the through hole 142, a notch 144 cut through the opposing top and bottom surfaces corresponding to the notch 13 of the base frame 1, and a locating hole 145 vertically cut through the opposing top and bottom surfaces and disposed at one side relative to the notch 144 remote from the through hole 142. The position-limit guide 141 comprises an elongated sliding guide slot 1412 located in one upright sidewall 1411 of the substantially U-shaped sliding panel 14.

The spanner 2 comprises a spanner head 21, a pusher 22 located at one end of the spanner head 21, and a spanner handle 23 extended from an opposite end of the spanner head 21. The spanner head 21 comprises a mating coupling hole 20, at least one retaining hole 211 disposed adjacent to the mating coupling hole 20, and a position-limit coupling rod 212 located at a bottom side thereof. The pusher 22 is U-shaped, comprising a locating portion 221 and a pushing portion 222 respectively located at two distal ends thereof. The spanner handle 23 comprises a locating protrusion 231 located at a bottom side near a distal end thereof remote from the spanner head 21.

The rotary actuator 3 comprises a base member 31, a holder member 32, an axle member 33, a spring member 332, a cap member 34, a rotary socket 35, and two mating curved tracks 36 respectively located at the base member 31 and the rotary socket 35. The base member 31 comprises a positioning space 310 defined therein, an axial center hole 311 cut through a bottom wall thereof in communication with the positioning space 310, and at least one retaining protrusion 312 located at a bottom side thereof. The holder member 32 comprises a center axle hole 320 for receiving the axle member 33. The axle member 33 is movably upwardly inserted through the center axle hole 320 of the holder member 32, having an expanded bottom end portion 331 thereof downwardly movable in and out of the axial center hole 311 of the base member 31. The spring member 332 is sleeved onto the axle member 33 and supported on the expanded bottom end portion 331. The cap member 34 is affixed to an opposing top end of the axle member 33 remote from the expanded bottom end portion 331 of the axle member 33. The rotary socket 35 is rotatably mounted on the holder member 32 over the cap member 34 and stopped against the base member 31. The curved track 36 comprises two opposite lifting portions 361, two homing grooves 362 equally spaced between the lifting portions 361 at two opposite sides, two sloping guide surfaces 363 respectively downwardly extended from respective one ends of the lifting portions 361 to respective one ends of the homing grooves 362, and two upright stop edges 364 respectively connected between respective opposite ends of the lifting portions 361 and respective opposite ends of the sloping guide surfaces 363.

When assembling the spanner-controlled panel member coupling structure, place the sliding panel 14 in the accommodation chamber 10 of the base frame 1 to keep the through hole 142 of the sliding panel 14 in axial alignment with the axle hole 12 of the base frame 1, and then respectively insert the position-limit coupling rod 212 and locating protrusion 231 of the spanner 2 into the arched sliding slot 143 and locating hole 145 of the sliding panel 14 to keep the mating coupling hole 20 of the spanner 2 in axial alignment with the through hole 142 of the sliding panel 14 and the axle hole 12 of the base frame 1 and to have the spanner handle 23 be suspended above the notch 144 of the sliding panel 14 and the notch 13 of the base frame 1, and then insert the at least one retaining protrusion 312 of the base member 31 into the at least one retaining hole 211 of the spanner 2 to keep the axial center hole 311 of the base member 31 in axial alignment with the mating coupling hole 20 of the spanner 2, and then insert the expanded bottom end portion 331 of the axle member 33 through the axial center hole 311 of the base member 31 into the mating coupling hole 20 of the spanner 2, the through hole 142 of the sliding panel 14 and the axle hole 12 of the base frame 1, and then sleeve the spring member 332 onto the axle member 33, and then couple the center axle hole 320 of the holder member 32 to the axle member 33 to have the spring member 332 be received in the holder member 32 and supported between the expanded bottom end portion 331 of the axle member 33 and an inside wall of the holder member 32, and then fasten the cap member 34 to the axle member 33 above the holder member 32, and then fasten the rotary socket 35 to the cap member 34 around the holder member 32 to keep the curved track 36 in contact the mating curved top edge of the base member 31.

Further, the receiving space 140 of the sliding panel 14 is configured for holding an electronic device such as hard disk drive, mobile data storage device, CD-ROM, multimedia player, etc.

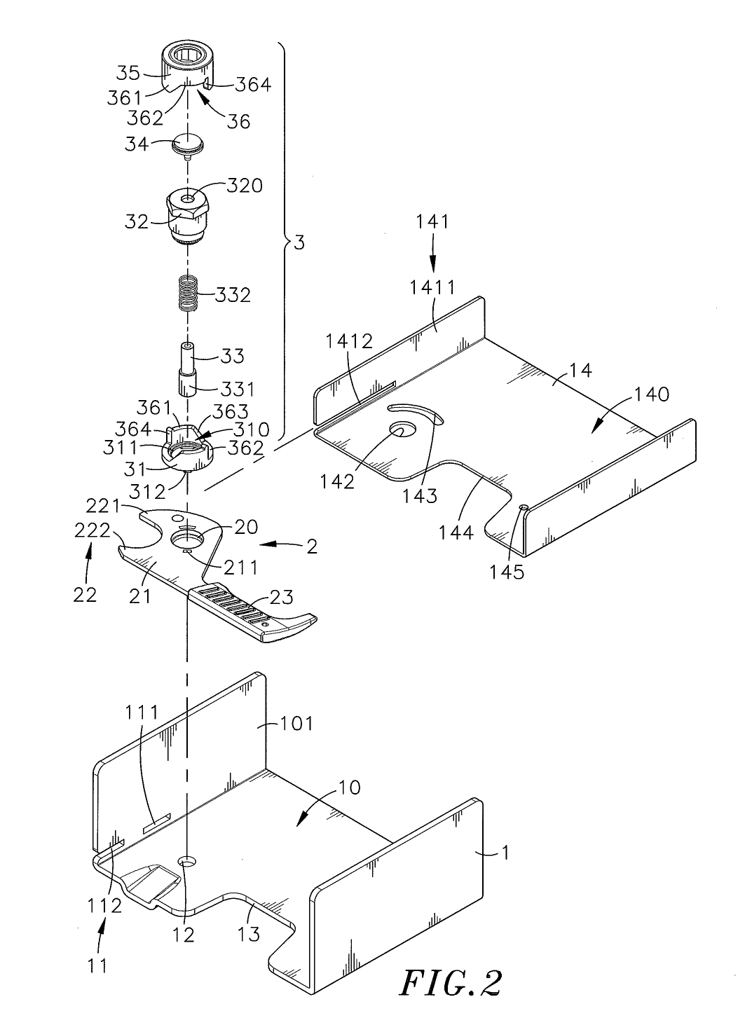

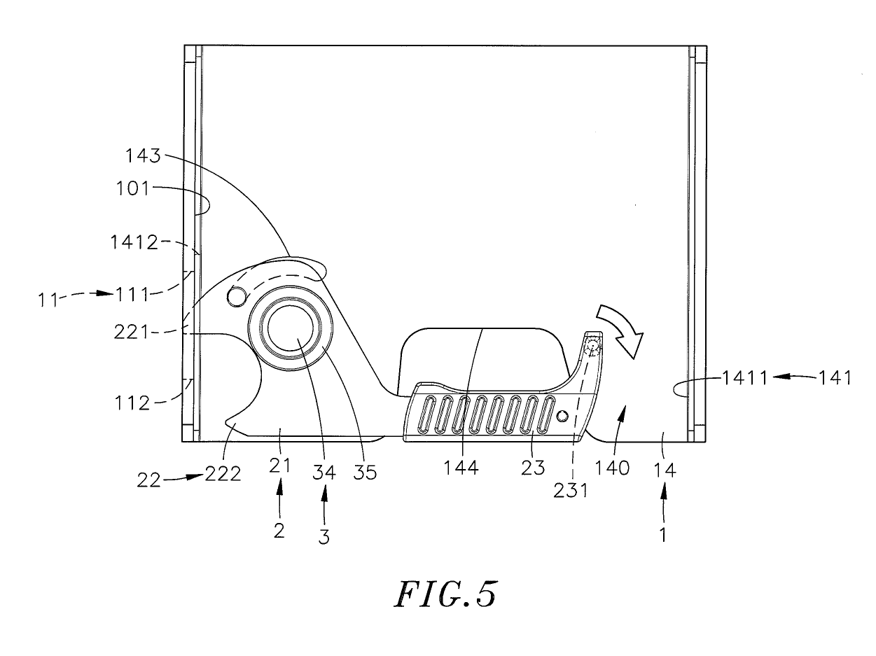

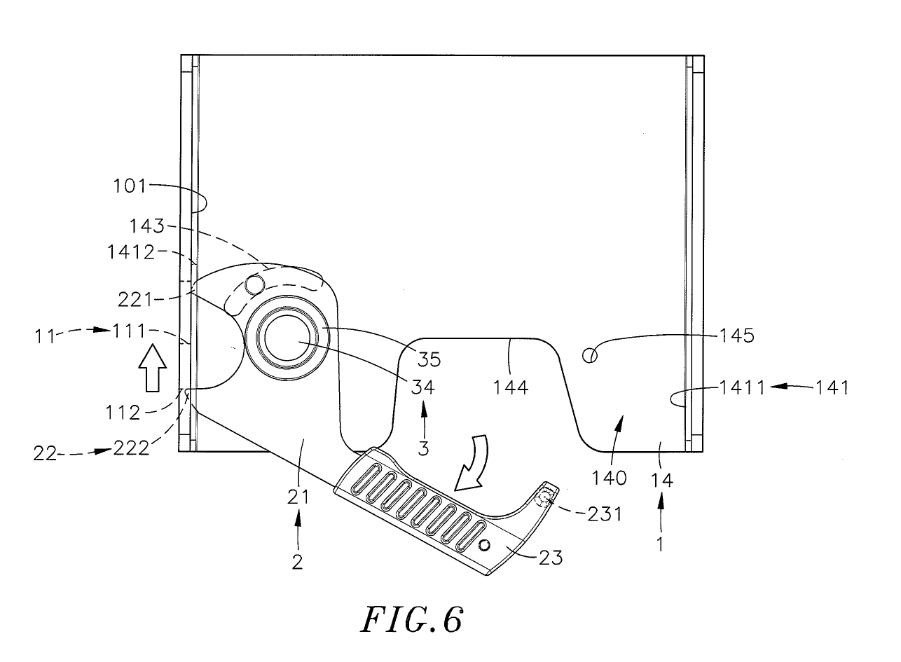

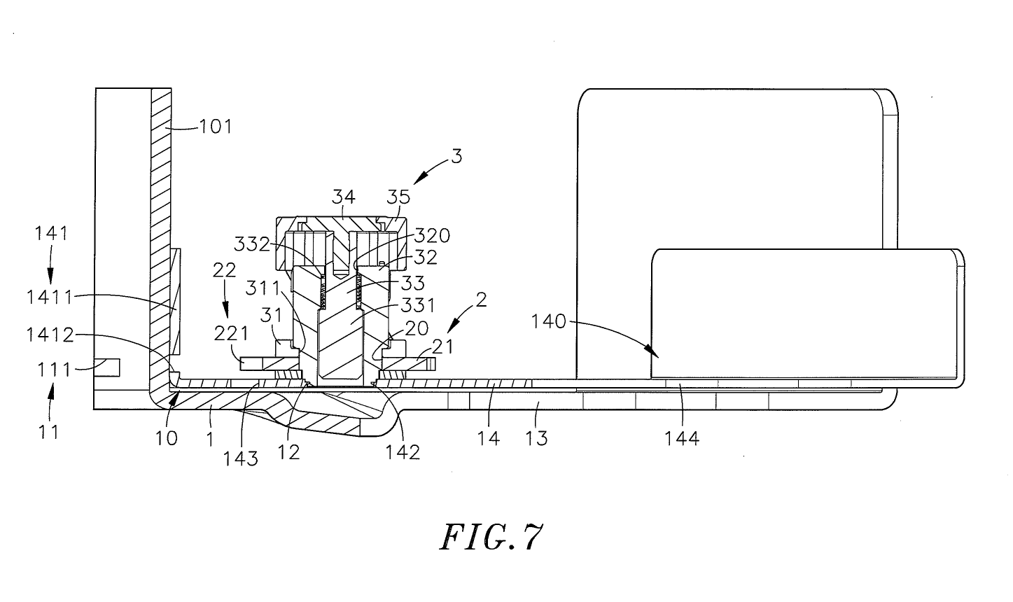

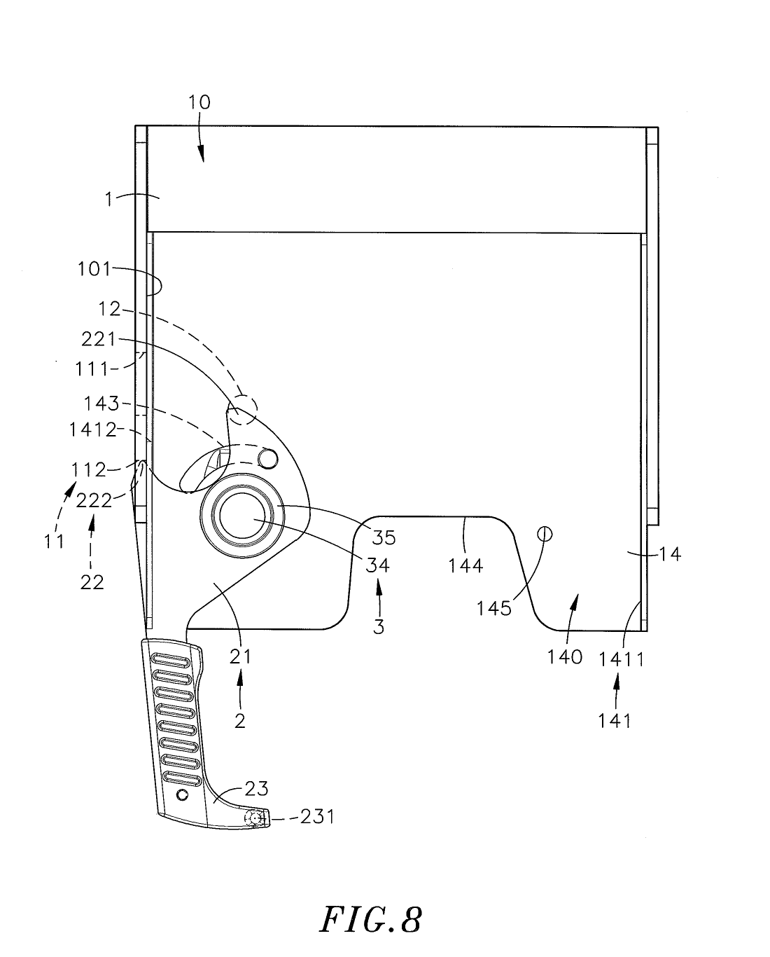

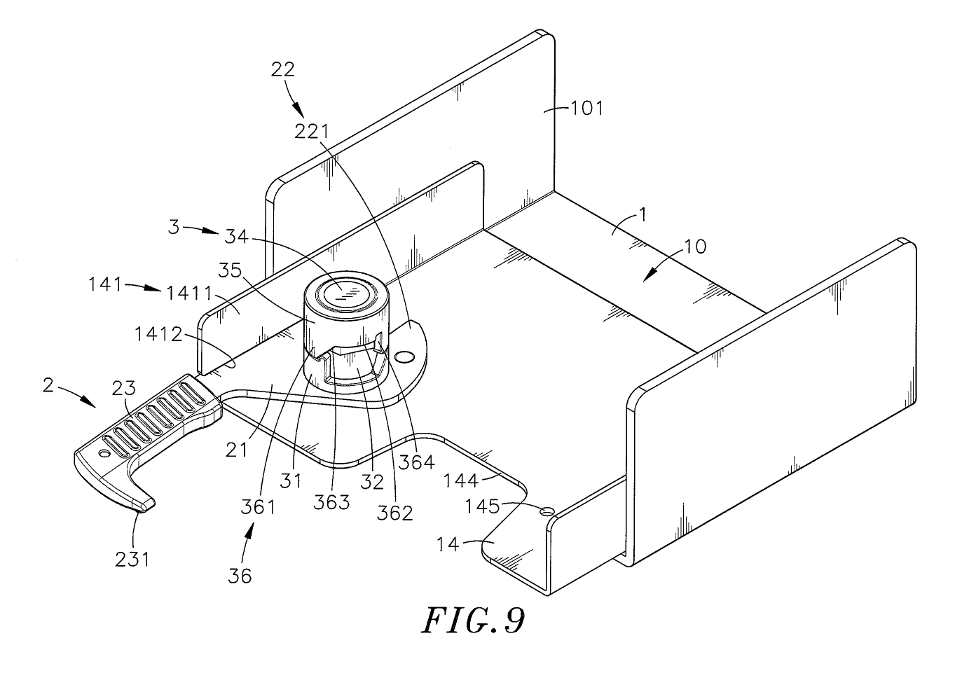

Referring to FIGS. 5-9 and FIGS. 2 and 3 again, the spanner 2 is operable to move the sliding panel 14 out of the base frame 1. The operation is as explained hereinafter. Turn the spanner handle 23 of the spanner 2 outwardly in direction away from the notch 144 of the sliding panel 14 and the notch 13 of the base frame 1 to disengage the locating protrusion 231 of the spanner 2 from the locating hole 145 of the sliding panel 14 and to move the pushing portion 222 of the pusher 22 into the sliding guide slot 1412 of the sliding panel 14 and the locating slot 112 of the position-limit structure 11. At this time, the pushing portion 222 of the pusher 22 is stopped at an inner end of the locating slot 112 of the position-limit structure 11. When continuously turning the spanner handle 23 of the spanner 2 in the same direction at this time, the base member 31 of the rotary actuator 3 is rotated relative to the rotary socket 35 and the base frame 1. During rotation of the base member 31 of the rotary actuator 3 relative to the rotary socket 35 and the base frame 1, the two opposite lifting portions 361 of the curved track 36 at the base member 31 are moved out of the two homing grooves 362 of the curved track 36 at the rotary socket 35 along the two sloping guide surfaces 363 of the curved track 36 at the rotary socket 35 to the lifting portions 361 of the curved track 36 at the rotary socket 35, at the same time, the two opposite lifting portions 361 of the curved track 36 at the rotary socket 35 are moved out of the two homing grooves 362 of the curved track 36 at the base member 31 along the two sloping guide surfaces 363 of the curved track 36 at the base member 31 to the lifting portions 361 of the curved track 36 at the base member 31. At this time, the rotary socket 35 is disposed at a relatively higher elevation to lift the cap member 34 and the axle member 33 relative to the base member 31, and thereby compressing the spring member 332 and disengaging the expanded bottom end portion 331 of the axle member 33 from the axle hole 12 of the base frame 1 and the through hole 142 of the sliding panel 14. When continuously turn the spanner handle 23 of the spanner 2 outward after the pushing portion 222 of the pusher 22 is stopped at the inner end of the locating slot 112 of the position-limit structure 11, the locating portion 221 of the pusher 22 will be disengaged from the retaining slot 111 of the position-limit structure 11, and the sliding panel 14 will be moved out of the accommodation chamber 10 of the base frame 1. Because the pushing portion 222 is inserted into the sliding guide slot 1412 of the position-limit guide 141 after the pushing portion 222 of the pusher 22 is stopped at the inner end of the locating slot 112 of the position-limit structure 11, turning the spanner 2 to pull the sliding panel 14 out of the accommodation chamber 10 of the base frame 1 does not cause any impact or friction damage. After the sliding panel 14 is moved out of the accommodation chamber 10 of the base frame 1, the user can install an electronic device (hard disk drive, mobile data storage device, CD-ROM, multimedia player, etc.) in the receiving space 140 of the sliding panel 14 conveniently.

When wishing to push the sliding panel 14 back to the inside of the accommodation chamber 10 of the base frame 1, turn the spanner handle 23 of the spanner 2 in the reversed direction toward the inside of the receiving space 140 of the sliding panel 14 to move the pushing portion 222 of the pusher 22 out of the sliding guide slot 1412 of the sliding panel 14 and the locating slot 112 of the position-limit structure 11 and the locating portion 221 of the pusher 22 into the sliding guide slot 1412 of the sliding panel 14 and the retaining slot 111 of the position-limit structure 11. At this time, the base member 31 of the rotary actuator 3 is rotated relative to the rotary socket 35 and the base frame 1. During rotation of the base member 31 of the rotary actuator 3 relative to the rotary socket 35 and the base frame 1, the two opposite lifting portions 361 of the curved track 36 at the base member 31 are moved away from the two opposite lifting portions 361 of the curved track 36 at the rotary socket 35 along the two sloping guide surfaces 363 of the curved track 36 at the rotary socket 35 to the homing grooves 362 of the curved track 36 at the rotary socket 35, and the two opposite lifting portions 361 of the curved track 36 at the rotary socket 35 are moved away from the two opposite lifting portions 361 of the curved track 36 at the base member 31 along the two sloping guide surfaces 363 of the curved track 36 at the base member 31 to the homing grooves 362 of the curved track 36 at the base member 31. At this time, the spring member 332 is released to push the expanded bottom end portion 331 of the axle member 33 downwardly out of the mating coupling hole 20 of the spanner 2 into the axle hole 12 of the base frame 1 and the through hole 142 of the sliding panel 14 to lock the sliding panel 14 in the accommodation chamber 10 of the base frame 1.

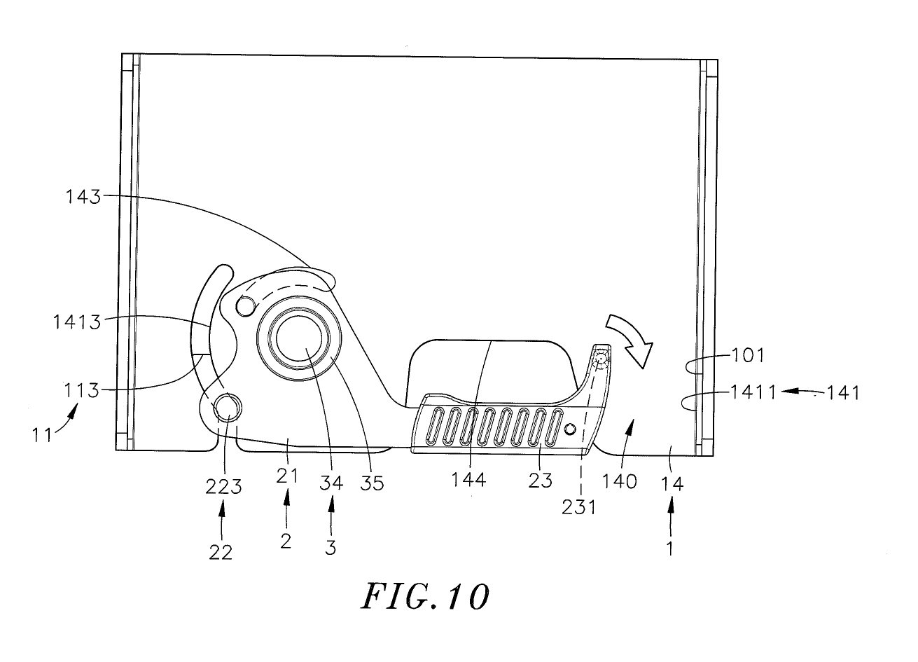

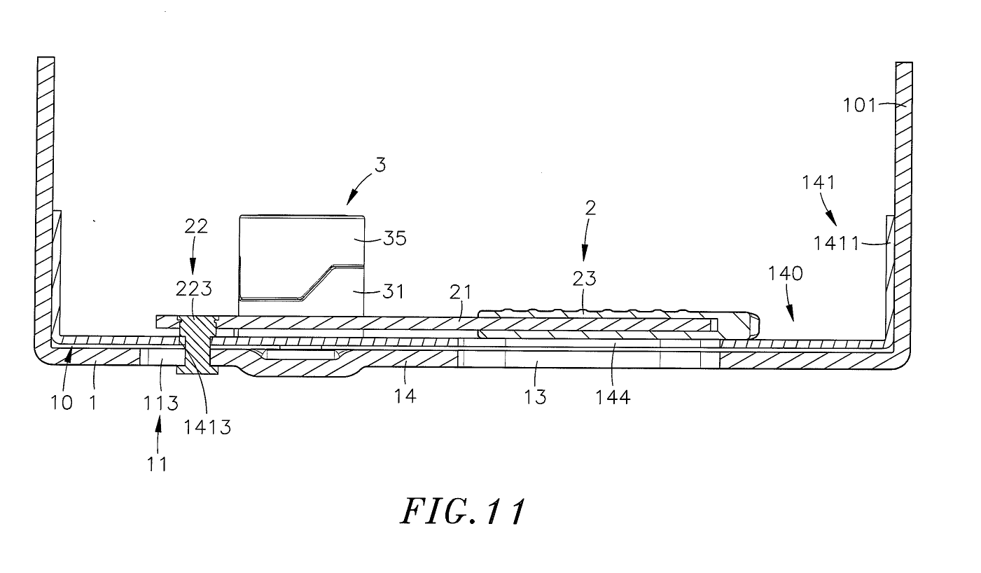

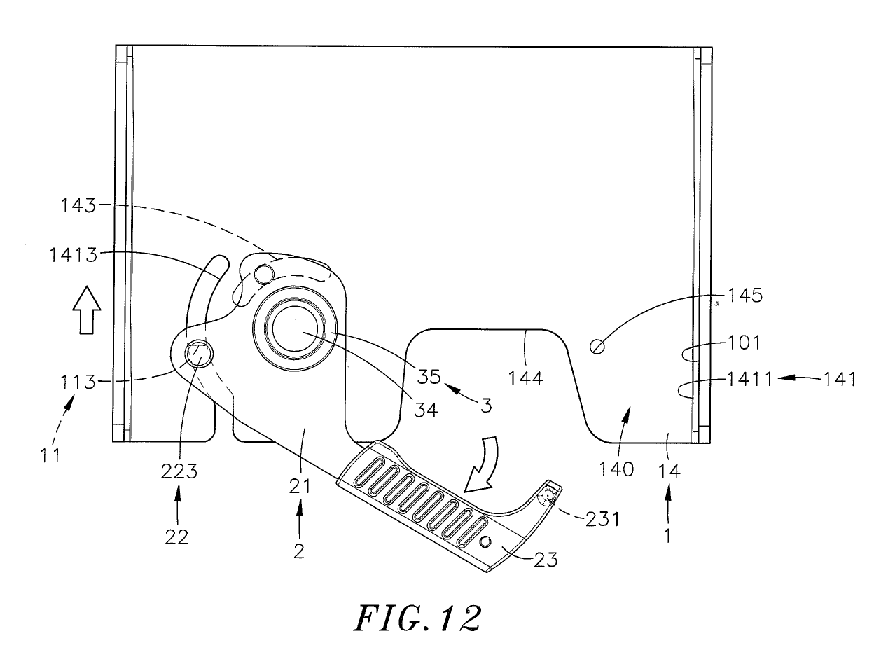

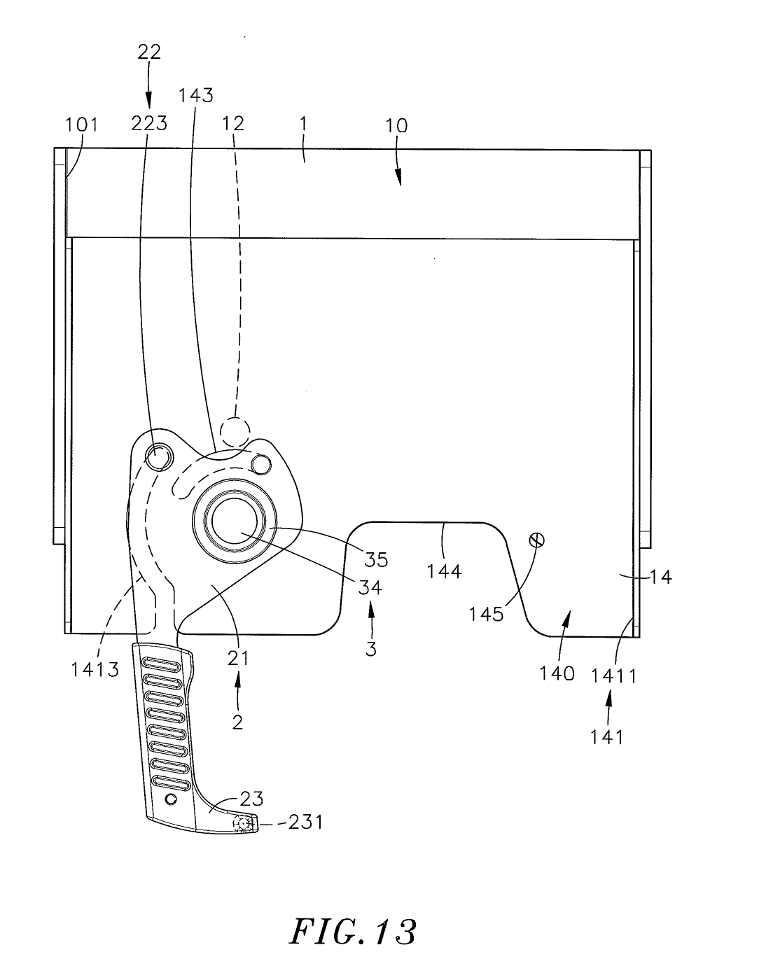

Referring to FIGS. 10-13, a spanner-controlled panel member coupling structure in accordance with a second embodiment of the present invention is shown. This second embodiment is substantially similar to the aforesaid first embodiment with the exception of the design of the pusher 22 of the spanner 2, the design of the position-limit guide 141 of the sliding panel 14, and the design of the position-limit structure 11 of the base frame 1. According to this second embodiment, the position-limit guide 141 of the sliding panel 14 comprises a smoothly arched guide slot 1413 spaced around the through hole 142 and extended to a front edge thereof; the position-limit structure 11 of the base frame 1 comprises a stop flange 113; the pusher 22 comprises a pushing rod 223 located at the bottom side of the spanner head 21 opposite to the position-limit coupling rod 212 and inserted through and movable along the smoothly arched guide slot 1413. When turning the spanner handle 23 of the spanner 2 outwardly in direction away from the notch 144 of the sliding panel 14 and the notch 13 of the base frame 1 to disengage the locating protrusion 231 of the spanner 2 from the locating hole 145 of the sliding panel 14, the pushing rod 223 of the pusher 22 is moved along the smoothly arched guide slot 1413 of the position-limit guide 141 of the sliding panel 14 and then stopped at the stop flange 113 of the position-limit structure 11 of the base frame 1, and the base member 31 of the rotary actuator 3 is rotated by the spanner 2 relative to the rotary socket 35 and the base frame 1 at the same time. When continuously outwardly turning the spanner handle 23 of the spanner 2 relative to the sliding panel 14 and the base frame 1, the base member 31 of the rotary actuator 3 will be continuously rotated relative to the rotary socket 35 and the base frame 1, causing the two opposite lifting portions 361 of the curved track 36 at the base member 31 to be moved out of the two homing grooves 362 of the curved track 36 at the rotary socket 35 along the two sloping guide surfaces 363 of the curved track 36 at the rotary socket 35 to the lifting portions 361 of the curved track 36 at the rotary socket 35. At the same time, the two opposite lifting portions 361 of the curved track 36 at the rotary socket 35 are moved out of the two homing grooves 362 of the curved track 36 at the base member 31 along the two sloping guide surfaces 363 of the curved track 36 at the base member 31 to the lifting portions 361 of the curved track 36 at the base member 31. At this time, the rotary socket 35 is disposed at a relatively higher elevation to lift the cap member 34 and the axle member 33 relative to the base member 31, and thereby compressing the spring member 332 and disengaging the expanded bottom end portion 331 of the axle member 33 from the axle hole 12 of the base frame 1 and the through hole 142 of the sliding panel 14. When continuously turn the spanner handle 23 of the spanner 2 outward after the pushing rod 223 of the pusher 22 is stopped at the stop flange 113 of the position-limit structure 11, the sliding panel 14 will be moved out of the accommodation chamber 10 of the base frame 1 without causing any impact or friction damage. After the sliding panel 14 is moved out of the accommodation chamber 10 of the base frame 1, the user can install an electronic device (hard disk drive, mobile data storage device, CD-ROM, multimedia player, etc.) in the receiving space 140 of the sliding panel 14 conveniently.

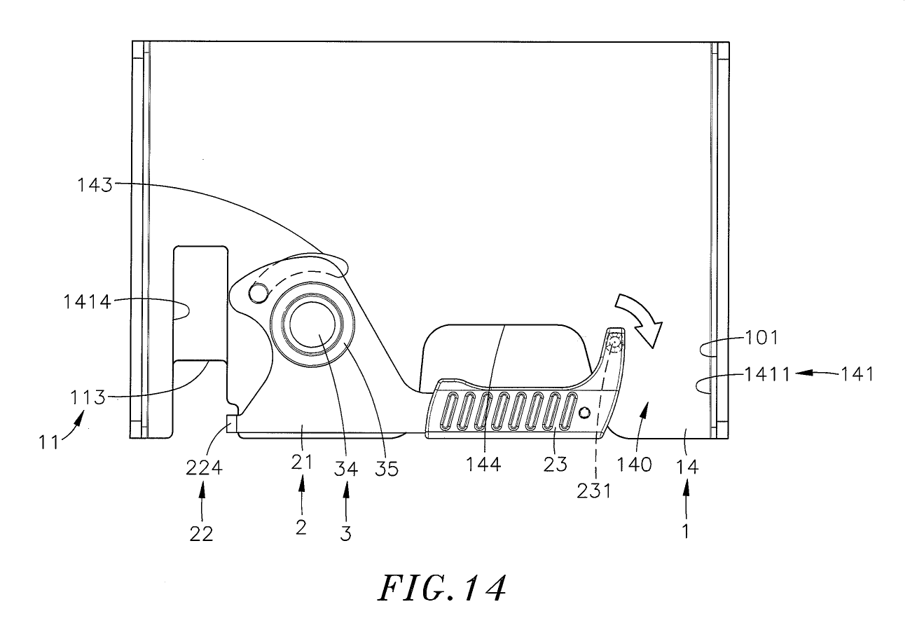

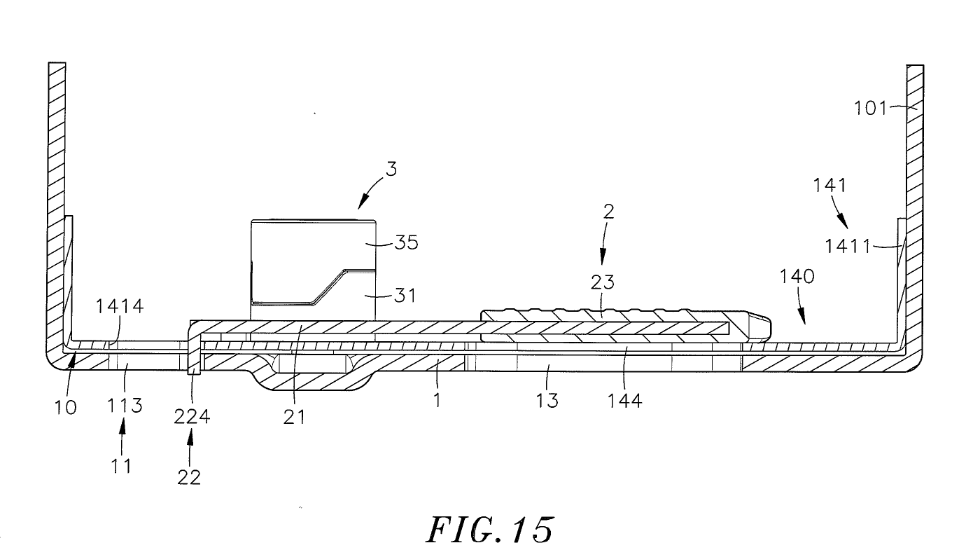

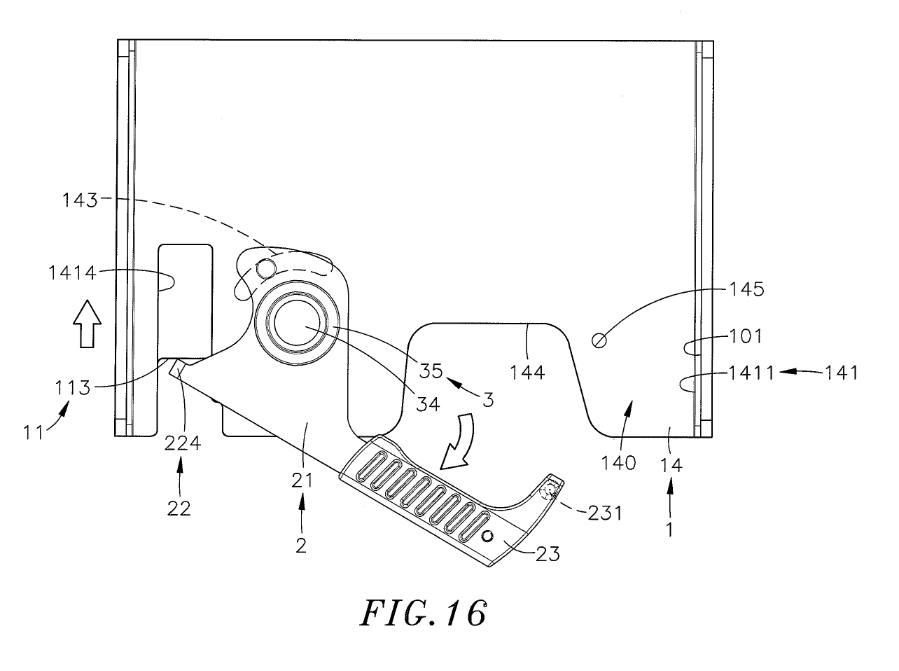

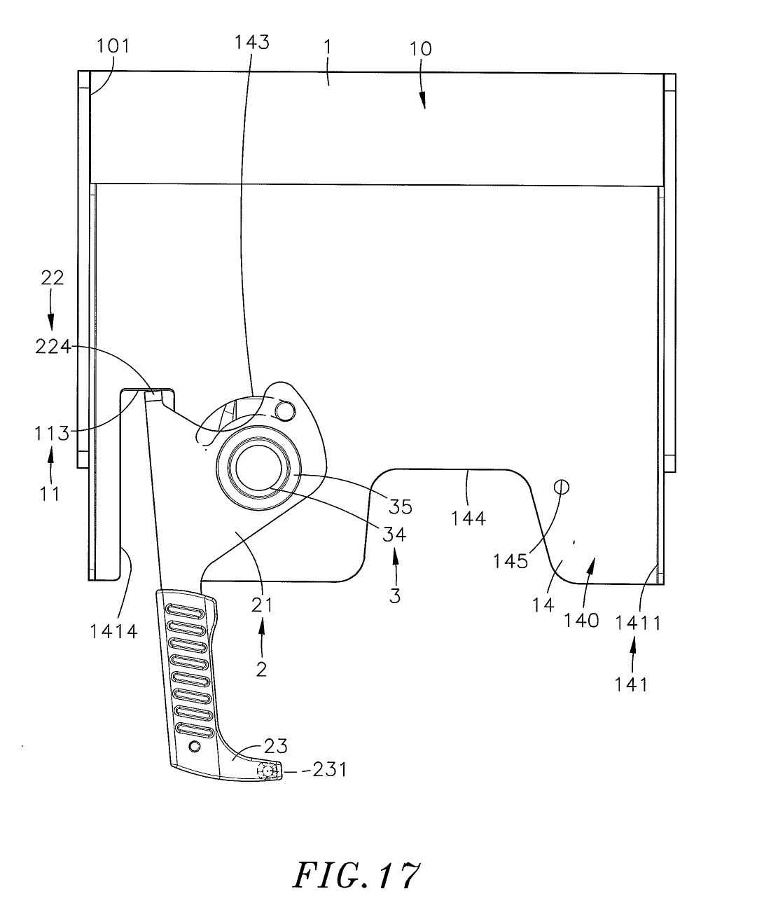

Referring to FIGS. 14-17, a spanner-controlled panel member coupling structure in accordance with a third embodiment of the present invention is shown. This third embodiment is substantially similar to the aforesaid first embodiment with the exception of the design of the pusher 22 of the spanner 2, the design of the position-limit guide 141 of the sliding panel 14, and the design of the position-limit structure 11 of the base frame 1. According to this third embodiment, the position-limit guide 141 of the sliding panel 14 comprises a straight guide slot 1414 perpendicularly backwardly extended from a front edge thereof; the position-limit structure 11 of the base frame 1 comprises a stop flange 113; the pusher 22 comprises a pushing rod 224 perpendicularly downwardly extended from a front side of the spanner head 21 and inserted through the straight guide slot 1413. When turning the spanner handle 23 of the spanner 2 outwardly in direction away from the notch 144 of the sliding panel 14 and the notch 13 of the base frame 1 to disengage the locating protrusion 231 of the spanner 2 from the locating hole 145 of the sliding panel 14, the pushing rod 224 of the pusher 22 is moved in the straight guide slot 1413 of the position-limit guide 141 of the sliding panel 14 and then stopped at the stop flange 113 of the position-limit structure 11 of the base frame 1, and the base member 31 of the rotary actuator 3 is rotated by the spanner 2 relative to the rotary socket 35 and the base frame 1 at the same time. When continuously outwardly turning the spanner handle 23 of the spanner 2 relative to the sliding panel 14 and the base frame 1, the base member 31 of the rotary actuator 3 will be continuously rotated relative to the rotary socket 35 and the base frame 1, causing the two opposite lifting portions 361 of the curved track 36 at the base member 31 to be moved out of the two homing grooves 362 of the curved track 36 at the rotary socket 35 along the two sloping guide surfaces 363 of the curved track 36 at the rotary socket 35 to the lifting portions 361 of the curved track 36 at the rotary socket 35. At the same time, the two opposite lifting portions 361 of the curved track 36 at the rotary socket 35 are moved out of the two homing grooves 362 of the curved track 36 at the base member 31 along the two sloping guide surfaces 363 of the curved track 36 at the base member 31 to the lifting portions 361 of the curved track 36 at the base member 31. At this time, the rotary socket 35 is disposed at a relatively higher elevation to lift the cap member 34 and the axle member 33 relative to the base member 31, and thereby compressing the spring member 332 and disengaging the expanded bottom end portion 331 of the axle member 33 from the axle hole 12 of the base frame 1 and the through hole 142 of the sliding panel 14. When continuously turn the spanner handle 23 of the spanner 2 outward after the pushing rod 223 of the pusher 22 is stopped at the stop flange 113 of the position-limit structure 11, the sliding panel 14 will be moved out of the accommodation chamber 10 of the base frame 1 without causing any impact or friction damage. After the sliding panel 14 is moved out of the accommodation chamber 10 of the base frame 1, the user can install an electronic device (hard disk drive, mobile data storage device, CD-ROM, multimedia player, etc.) in the receiving space 140 of the sliding panel 14 conveniently.

In conclusion, the invention provides a spanner-controlled panel member coupling structure comprising a base frame 1, a sliding panel 14, a spanner 2, and a rotary actuator 3, wherein the base frame 1 comprises an accommodation chamber 10, a position-limit structure 11 located in one upright sidewall 101 of the accommodation chamber 10, and an axle hole 12 located in a bottom side of the accommodation chamber 10; the sliding panel 14 is movable in and out of the accommodation chamber 10, comprising a receiving space 140, a position-limit guide 141 disposed at one lateral side of the receiving space 140 and a through hole 142 vertically cut through opposing top and bottom surfaces thereof in communication with the receiving space 140; the spanner 2 comprises a spanner head 21, a pusher 22 located at one end of the spanner head 21, a spanner handle 23 extended from an opposite end of the spanner head 21 and a mating coupling hole 20 coupled to the through hole 142 of the sliding panel 14 and the axle hole 12 of the base frame 1; the rotary actuator 3 comprises a base member 31 mounted on the spanner head 21 of the spanner 2, a holder member 32 mounted in the base member 31, an axle member 33 mounted in the holder member 32 and axially movable between a locking position where the axle member 33 is engaged into the through hole 142 of the sliding panel 14 and the axle hole 12 of the base frame 1 and an unlocking position where the axle member 33 is disengaged from the through hole 142 of the sliding panel 14 and the axle hole 12 of the base frame 1, a spring member 332 mounted in the holder member 32 and adapted to hold the axle member 33 in the locking position where the axle member 33 is engaged into the through hole 142 of the sliding panel 14 and the axle hole 12 of the base frame 1, a cap member 34 affixed to the top end of the axle member 33 outside the holder member 32, a rotary socket 35 affixed to the cap member 34, and two mating curved tracks 36 respectively located at the base member 31 and the rotary socket 35 and mating each other. When the user biases the spanner 2, the base member 31 is rotated with the spanner 2 relative to the rotary socket 35, and the rotary socket 35 is moved to lift the axle member 33 from the locking position to the unlocking position subject to the relative rotary motion between two mating curved tracks 36, causing the sliding panel 141 to be moved out of the accommodation chamber 10 of the base frame 1 subject to the functioning of the pusher 22 and the position-limit structure 11 of the base frame 1.

A prototype of spanner-controlled panel member coupling structure has been constructed with the features of FIGS. 1-16. The spanner-controlled panel member coupling device functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A spanner-controlled panel member coupling structure, comprising:
a base frame comprising an accommodation chamber, a position-limit structure located in one upright sidewall of said accommodation chamber, and an axle hole and a notch located in a bottom side of said accommodation chamber;
a sliding panel movable in and out of said accommodation chamber between an extended position and a received position, said sliding panel comprising a receiving space, a position-limit guide disposed at one lateral side of said receiving space, a through hole vertically cut through opposing top and bottom surfaces thereof corresponding to said axle hole of said base frame, and an arched sliding slot vertically cut through the opposing top and bottom surfaces and extending around said through hole, and a notch corresponding to said notch of said base frame;
a spanner comprising a spanner head, a pusher located at one end of said spanner head and a spanner handle extended from an opposite end of said spanner head, said spanner head comprising a mating coupling hole rotatably coupled to said through hole of said sliding panel, a position-limit coupling rod located at a bottom side thereof and slidably coupled to said arched sliding slot of said sliding panel; and
a rotary actuator comprising a base member affixed to said spanner head of said spanner, a holder member mounted in said base member, an axle member mounted in said holder member axially movable between a locking position where said axle member is engaged into said through hole of said sliding panel and said axle hole of said base frame and an unlocking position where said axle member is disengaged from said through hole of said sliding panel and said axle hole of said base frame, a spring member mounted in said holder member and adapted to hold said axle member in said locking position, a cap member affixed to a top end of said axle member outside said holder member, a rotary socket affixed to said cap member, and two mating curved tracks respectively located at said base member and said rotary socket and mating each other for guiding rotation of said rotary socket relative to said base member to move said axle member between said locking position and said unlocking position when a user biases said spanner handle of said spanner in or out of said notch of said sliding panel and said notch of said base frame.

2. The spanner-controlled panel member coupling structure as claimed in claim 1, wherein said position-limit structure comprises a retaining slot and a locating slot aligned in line for receiving said pusher of said spanner; said position-limit guide comprises an elongated sliding guide slot located in one upright sidewall of said sliding panel corresponding to the aligned said retaining slot and said locating slot of said position-limit structure.

3. The spanner-controlled panel member coupling structure as claimed in claim 1, wherein said position-limit structure of said base frame comprises a stop flange for stopping against a part of said spanner head of said spanner; said position-limit guide of said sliding panel comprises a smoothly arched guide slot spaced around said through hole and extended to a front edge thereof for guiding movement of said spanner head of said spanner.

4. The spanner-controlled panel member coupling structure as claimed in claim 1, wherein said position-limit structure of said base frame comprises a stop flange for stopping against a part of said spanner head of said spanner; said position-limit guide of said sliding panel comprises a straight guide slot perpendicularly backwardly extended from a front edge thereof for guiding movement of said spanner head of said spanner.

5. The spanner-controlled panel member coupling structure as claimed in claim 1, wherein said pusher is U-shaped, comprising a locating portion and a pushing portion respectively located at two distal ends thereof; said position-limit structure comprises a retaining slot and a locating slot aligned in line for receiving said locating portion and said pushing portion of said pusher of said spanner respectively; said position-limit guide comprises an elongated sliding guide slot located in one upright sidewall of said sliding panel corresponding to the aligned said retaining slot and said locating slot of said position-limit structure for receiving said locating portion and said pushing portion of said pusher of said spanner.

6. The spanner-controlled panel member coupling structure as claimed in claim 1, wherein said position-limit guide of said sliding panel comprises a smoothly arched guide slot spaced around said through hole and extended to a front edge thereof; said pusher comprises a pushing rod located at a bottom side of said spanner head and inserted through and movable along said smoothly arched guide slot.

7. The spanner-controlled panel member coupling structure as claimed in claim 1, wherein said spanner head of said spanner comprises at least one retaining hole disposed adjacent to said mating coupling hole; said base member of said rotary actuator comprises at least one retaining protrusion located at a bottom side thereof and respectively fastened to said at least one retaining hole of said spanner head of said spanner.

8. The spanner-controlled panel member coupling structure as claimed in claim 1, wherein each said curved track comprises two opposite lifting portions, two homing grooves equally spaced between said lifting portions at two opposite sides, two sloping guide surfaces respectively downwardly extended from respective one ends of said lifting portions to respective one ends of said homing grooves, and two upright stop edges respectively connected between respective opposite ends of said lifting portions and respective opposite ends of said sloping guide surfaces.

9. A spanner-controlled panel member coupling structure, comprising:
a spanner comprising a spanner head, a pusher located at one end of said spanner head and a spanner handle extended from an opposite end of said spanner head, said spanner head comprising a mating coupling hole for rotatably coupling to a through hole of an external object, a position-limit coupling rod located at a bottom side thereof and for slidably coupling to an arched sliding slot of said external object; and
a rotary actuator comprising a base member affixed to said spanner head of said spanner, a holder member mounted in said base member, an axle member mounted in said holder member axially movable between a locking position where said axle member extends out of a bottom side of said base member and an unlocking position where said axle member is received inside said base frame, a spring member mounted in said holder member and adapted to hold said axle member in said locking position, a cap member affixed to a top end of said axle member outside said holder member, a rotary socket affixed to said cap member, and two mating curved tracks respectively located at said base member and said rotary socket and mating each other for guiding rotation of said rotary socket relative to said base member to move said axle member between said locking position and said unlocking position when a user operates said spanner handle of said spanner to rotate said base frame relative to said rotary socket.

10. The spanner-controlled panel member coupling structure as claimed in claim 9, wherein said spanner head of said spanner comprises at least one retaining hole disposed adjacent to said mating coupling hole; said base member of said rotary actuator comprises at least one retaining protrusion located at a bottom side thereof and respectively fastened to said at least one retaining hole of said spanner head of said spanner.

11. The spanner-controlled panel member coupling structure as claimed in claim 9, wherein each said curved track comprises two opposite lifting portions, two homing grooves equally spaced between said lifting portions at two opposite sides, two sloping guide surfaces respectively downwardly extended from respective one ends of said lifting portions to respective one ends of said homing grooves, and two upright stop edges respectively connected between respective opposite ends of said lifting portions and respective opposite ends of said sloping guide surfaces.
